(19) United States
(12) Patent Application Publication
(10) Pub. No.: US 2011/0110209 A1
(43) Pub. Date: May 12, 2011

(54) OPTICAL INFORMATION MEDIA, SYSTEMS, AND METHODS FOR PROVIDING UBIQUITOUS READ AND SELECTIVE WRITE

(76) Inventors: Erik C. BARD, Lehi, UT (US); Douglas P. Hansen, Spanish Fork, UT (US); Mark O. Worthington, Montrose, CA (US)

(21) Appl. No.: 12/915,919

(22) Filed: Oct. 29, 2010

Related U.S. Application Data
(60) Provisional application No. 61/256,882, filed on Oct. 30, 2009.

(51) Int. Cl. G11B 20/00; G11B 7/24

(52) U.S. Cl. 369/47.15; 369/275.3; G9B/20; G9B/7

(57) ABSTRACT

An optical information media, system, and method for providing ubiquitous reading and selective writing is disclosed. By placing data structures representing a nonstandard book type in byte “0” of the media, the media is made universally bootable and universally readable in substantially any DVD drive. On the other hand, data structure representing a version code or disc category is placed in byte “0” or another byte of the control data zone in order to identify the media and enable writing in select drives. The version code and/or disc category identifies the media and calls for one or more write strategies configured for writing to the particular media. When the media is a permanent storage media, loss of data can be avoided, ubiquitous read can be achieved, and selective write in predetermined drives can be achieved resulting in a robust system and method of storing and retrieving data.

### CROSS REFERENCE TO RELATED APPLICATIONS

Priority is claimed from U.S. Provisional Patent Application 61/256,882, filed 30 Oct. 2009, which is hereby incorporated by reference

### BACKGROUND

In optical disc technology, the book type is a field of four bits at the start of every DVD. These four bits are also referred to as byte 0 “byte zero” and they are located in the physical format information section of the control data zone. The physical information section includes bytes “0” through “31” (the first 32 bytes of storage space on the disc). The book type conventionally indicates the physical format of the disc. Many reading/writing devices will use the book type that has been encoded on the disc to determine how the disc should be treated by the reading/writing device. For example, if the media is a DVD-rewritable disc (−RW), then the book type (version number 0010 and disc category 0011) tells the reading/writing device that the media can be rewritten and indicates that writing should be undertaken in accordance with a −RW strategy.

The standard book types are as follows: ECMA-267/268 (DVD-RO), ECMA-272 (DVD-RAM 2.6 GBytes), ECMA-330 (DVD-RAM), ECMA-279 (DVD-R 3.95 Gbytes, ECMA-359 (DVD-R), ECMA-338 (DVD-RW), ECMA-274 (+RW 3.0 Gbytes), ECMA-337 (+RW), ECMA-371 (+RW HS), ECMA-349 (+R), ECMA-374 (+RW DL), and ECMA-364 (+R DL). The abbreviations in the book types above have the following meanings: RO means read-only, RAM means rewritable, R means recordable, RW means re-recordable, HS means high speed, and DL means dual layer. Different materials and combinations of materials can be used to achieve more or less re-recordable media.

For example, the recording layer in DVD+RW and DVD-RW discs is a phase change metal alloy (often GeSbTe) whose crystalline phase and amorphous phases have different reflectivity. For example, the DVD+RW has a reflectivity of about eighteen percent to about thirty percent. The phase states of the DVD+RW and the DVD-RW discs can be switched by changing the power of the writing laser. Thus, the data can be written, read, erased and re-written, as desired. These +RW and −RW formats and associated disc structures have been developed for particular purposes and have particular strengths. For example, it is estimated that DVD-RW discs can be read in approximately seventy-five percent of commercially available read/write devices. The readability of DVD+RW discs is overall much lower in commercially available read/write devices.

DVD+R and DVD-R discs use an organic dye. DVD+R is a format for optical data storage. It is similar to, but incompatible with, the earlier DVD-R standard. DVD+R and DVD-R are write-once optical discs with approximately 4.7 gigabytes of storage. The DVD+R and DVD-R formats are generally used for nonvolatile data storage or video applications because, unlike DVD+RW discs and DVD-RW discs, DVD+R discs can only be written to one time. Hybrid drives that can handle both “plus” and “minus” formats, often labeled “DVD±RW”, are very popular since there is not a single standard for recordable DVDs. These hybrid drives still fall short in booting and reading all DVD discs universally.

The recordable DVD market shows little sign of settling down in favor of either the “dash/minus” or the “plus” format. Since almost all new DVD writers can record to both formats, this is not an issue for many users. However when creating DVDs for distribution (where the reading/playing device is unknown or older) using DVD-R format would may be advisable because most older (up to 2004) standalone DVD video players and DVD ROM drives only support the earlier DVD-R format.

There are a number of significant technical differences between the “minus” and the “plus” format, although most users would not notice the difference. One example is that the DVD+R style ADIP (Address Data In Pregroove) system of tracking and speed control is less susceptible to interference and error which makes the ADIP system more accurate at higher speeds than the LPP (Land Pre Pit) system used by DVD-R. In addition, DVD+R(W) has a more robust error management system than DVD-R(W), allowing for more accurate burning to media independent of the quality of the media. Additional session linking methods are more accurate with DVD+R(W) versus DVD-R(W), resulting in fewer damaged or unusable discs due to buffer under-run and multi-session disks with fewer PI/PO errors.

One common cause of compatibility problems is the failure of a reading device to recognize the book type of the disc that has been loaded. This can occur, for example, when the reading device was manufactured before that particular book type was defined and standardized. By way of example, most DVD playback devices made before mid-2004 will not recognize the relatively new DVD+R DL (dual layer) book type. For DVD+R, DVD+RW, and DVD+R DL (dual layer) discs, it is possible to change the book type field value to the value for DVD-ROM (or in some rare and unorthodox cases, even the value for DVD-R) in order to fool older devices that do not recognize newer book type field values (this process is known as bitsetting).

Still, the recordable DVD market shows little sign of settling down in favor of either the “dash/minus” or the “plus” formats. The problem still exists that a user may not be able to access information on his/her media because a large percentage of drives do not read discs having each specific book type. Accordingly, there exists a need to overcome the drawback of having various optical media formats available, the problem of only a percentage of the drives reading a particular media, and other problems that will be discussed below.

### SUMMARY

Embodiments are directed generally to optical information media, systems, and methods, and more particularly to optical information media, systems, and methods that provide reading by a broad range of readers and writing to the media with a narrow range of writers.

To meet this need, embodiments are directed to an optical information media, system, and method for providing reading by a broad range of readers and writing by a select one or few writers. By placing data structures representing a nonstandard book type in byte “0” of the media, the media is made universally bootable and universally readable in substantially any DVD drive. On the other hand, data structure representing a version code or disc category is placed in byte “0” or another byte of the control data zone in order to identify the media and enable writing by only a select few drives, or only one drive make and model, for example. The version code and/or disc category identifies the media and calls for one or more write strategies that are configured for writing to the media. When the media is a permanent storage media, loss of data can be avoided. Additionally, ubiquitous reading and selective writing in predetermined drives can be achieved. The result is a more robust system and method of storing and retrieving data than has been previously available.

### DESCRIPTION OF THE FIGURES

FIG. 1 shows a bottom plan view of an optical information media disc.

FIG. 2A shows a table of conventional book types that have been established as standard book types.

FIG. 2B shows a table of book types in which the version numbers are represented by standard binary values and the disc categories are represented by nonstandard binary values.

FIG. 2C shows a table of book types in which the version numbers have nonstandard binary values and the disc categories have standard binary values.

FIG. 2D shows a table of book types in which the version numbers have nonstandard binary values and the disc values have nonstandard binary values.

FIG. 3 shows a system, including a drive and user interfaces.

FIG. 4 shows a block diagram illustrating a method of using a driver that is configured to write to an optical information media, which method provides ubiquitous reading and selective writing.

FIG. 5 shows a block diagram illustrating a method of using a conventional driver to boot/read an optical information media, which method provides ubiquitous reading and selective writing.

### DETAILED DESCRIPTION

As discussed above, there are many disk types among the conventional optical information media currently available. These available discs are book typed with established standard version numbers and disk categories associated with particular disc formats that are recognized by conventional disc drives. The firmware in the disc drives is configured to boot these discs and provide appropriate functionality. For example, the capability of writing or rewriting is provided for a DVD+RW having a particular pre-defined standard version number. Different write strategies have been developed for different drives and to accommodate discs having a variety of disc formats. However, there are limited functional compatibilities between certain brands and formats of discs and certain brands, makes, and models of drives. Thus, there is a percentage of drives that will not boot, read, or write each conventional disc. Furthermore conventional optical discs are prone to degradation over time, such that data can easily be lost before it is backed up.

A problem to be addressed is the potential loss of data due to degradation. On the other hand, of similar relevance is the problem of not being able to read optical information media in any drive with few or no exceptions. This is especially true for discs and drives that should be backward compatible, but are not. It is acceptable that there may be at least one predetermined drive capable of permanently writing to an optical information media configured for permanent data storage. The predetermined drive may have a particular make and model. Other makes and models may also be developed to permanently write data to the permanent data storage media. In any case, the media may have the data permanently stored by this drive so that it will not be lost, and the data may be readable in any of a variety of drives. Thus, there has been a need for an optical information media, system, and method having ubiquitous readability and selected writability. Such media, system and method are provided as disclosed herein.

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

Materials

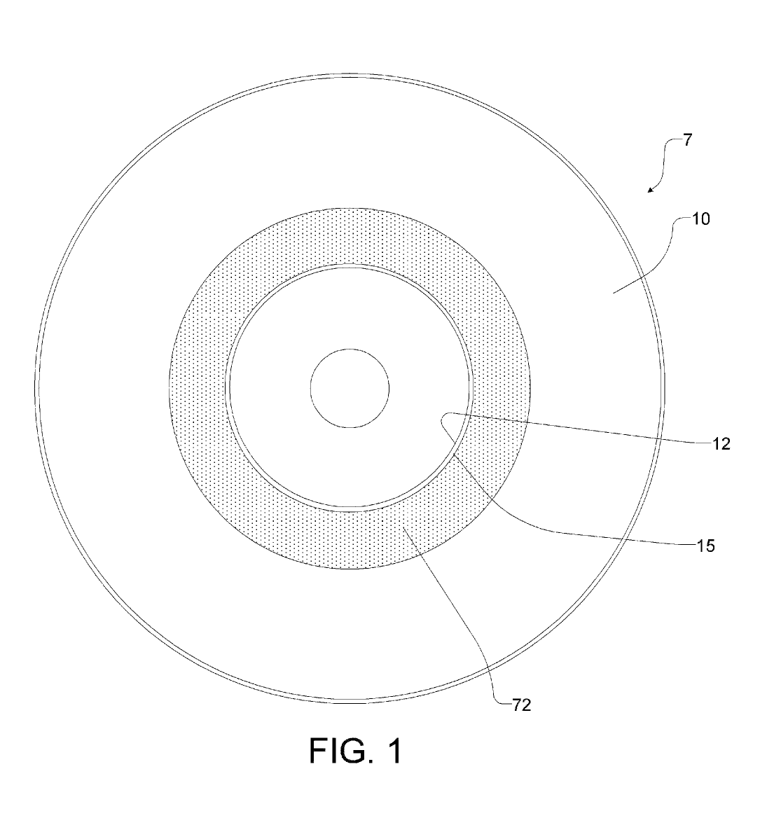

FIG. 1 shows a bottom plan view of an optical information media disc 7. The media 7 has a data area 10 in which data is stored along concentric or spiral tracks. Reading generally starts at an inner diameter 12 of the data area 10, and occurs along a prerecorded region of the tracks called a control data zone 15. The control data zone 15 has two hundred fifty-five bytes of storage space. Data is prerecorded to portions of the control data zone 15 for a variety of control purposes, including identification of the media 7 by format version number and disc category. The combination of the version number and the disc category is termed the “book type”, and binary numbers representing the values of the version number and the disc category are typically prerecorded in byte “0” of the control data zone.

In an embodiment, digital information media 7 has a control data zone 15 including a book type having a binary value that indicates other than a standard version number or a standard disc category.

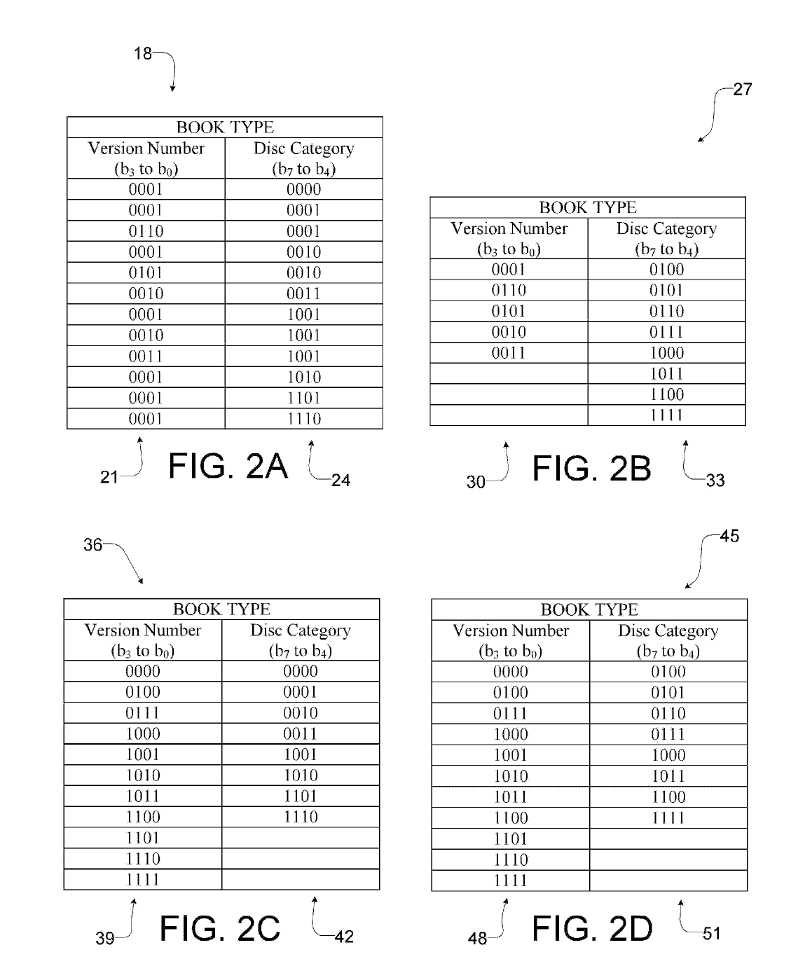

FIG. 2A shows a table 18 of conventional book types that have been established as standard book types in the optical disc industry. These book types are published by a standards organization named ECMA (formerly European Computer Manufacturers Association). The two columns provide cells for version number 21 and disc category 24 for twelve established standard book types shown in respective rows. For example, the top row has a version number represented by the binary value 0001₂, which by definition represents version “ECMA-267/268”. The disc category 24 of the top row is represented by the binary value of 0000₂, which by definition represents the disc category of “DVD-RO” (ROM). The remaining eleven rows of table 18 show a variety of ECMA versions and associated disc categories, representing two types of DVD-RAM, two types of DVD-R, a DVD-RW, three types of DVD+RW (single layer), a DVD+R, a DVD+RW (dual layer), and a DVD+R (dual layer), respectively. The version number 21 and the disc category 24 values are not conventionally mixed and matched from one row to another. Rather, each row represents a specific, unique format and version of data. These specific formats actually limit the number of drives and the specific drives that can boot, read, and/or write the disc 7.

On the other hand, by mixing the codes to create book types in a manner that is not yet standardized creates an undefined value for the book type of a disc 7 in which the mixing is implemented. It has been discovered that by mixing the codes in nonstandard combinations allows the disc 7 to be booted, read, and/or written in substantially any drive. Thus, in one embodiment, a digital information media includes a control data zone having a book type with a binary value that indicates a nonstandard disc category or a nonstandard version number. In a simple form, this can be achieved by providing a book type that is not from the list of standard book types, which in big endian format consists of 0000₂ 0001₂, 0001₂ 0001₂, 0001₂ 0110₂, 0010₂ 0001₂, 0010₂ 0101₂, 0011₂ 0010₂, 1001₂ 0001₂, 1001₂ 0010₂, 1001₂ 0011₂, 1010₂ 0001₂, 1101₂ 0001₂, and 1110₂ 0001₂. That is, book types other than those listed above (the ECMA standard booktypes) where the first four digits represent the disc category and bits 7 through 4, and the second four digits represent the version number and bits 3 through 0. The subscript 2 represents base two or binary format. In big endian format, the book types represent the disc category first as bits 7 through 4, and the version number second as bits 3 through 0. Other formats including little endian could be used without limitation.

In particular, it is desirable that the discs be readable substantially universally in all DVD drives once data has been permanently recorded to the discs 7. In one example this is accomplished by prerecording the version number of 0010₂, (which is a standard version number value associated with at least one disc category), and prerecording the disc category of 1010₂, (which is a standard disc category value associated with at least another version number). Prerecording these values together to create the book type results in a new nonstandard book type that enables ubiquitous read capability of the disc 7 independent of the drive being used. In another example of a newly created, nonstandard book type, the version number of 0010₂ is prerecorded, as before. On the other hand, another disc category value of 0000₂ (representing ROM) is prerecorded in byte “0”. These two values are not a standard combination that defines a predetermined book type. Thus, they are not recognized by most or all conventional DVD drives, and the values are not used to limit readability of the disc 7 in substantially any DVD drive. This mixing and matching of version numbers 21 in one row and disc categories 24 in another row in the table 18 can be undertaken to provide undefined or nonstandard book types, without limitation. It is to be understood that prerecording as used herein may include writing with a laser, stamping with a preformed stamper during manufacture, or other procedures for placing the data structure in the tracks at the book type portion of the control data zone 15.

FIG. 2B shows a table 27 of book types in which the version numbers 30 have standard binary values similar to the version numbers 21 shown in FIG. 2A. However, the disc categories 33 have nonstandard binary values that are not in the list of standard disc categories 24 shown in FIG. 2A. These nonstandard disc category values include binary values selected from among 0100₂, 0101₂, 0110₂, 0111₂, 1000₂, 1011₂, 1100₂, and 1111₂. In this way, the combinations shown in the rows of table 27 create nonstandard book types. Furthermore, other combinations of any version number 30 with any disc category 33 may be prerecorded to byte “0” of the control data zone 15 to create any number of nonstandard book types. These nonstandard book types enable ubiquitous reading of the disc 7 in substantially any DVD drive for the same benefits described above relative to creating nonstandard book types.

FIG. 2C shows a table 36 of book types in which the version numbers 39 have nonstandard binary values and the disc categories 42 have standard binary values similar to the disc categories 24 shown in the table of FIG. 2A. The nonstandard version numbers 39 have binary values that are not shown in the list of standard version numbers 21 of FIG. 2A. The nonstandard version numbers include binary values selected from among 0000₂, 0100₂, 0111₂, 1000₂, 1001₂, 1010₂, 1011₂, 1100₂, 1101₂, 1110₂, and 1111₂. In this way, the combinations shown in the rows of table 36 create nonstandard book types. Furthermore, other combinations of any version number 39 with any disc category 42 may be prerecorded to byte “0” of the control data zone 15 to create any number of nonstandard book types. These nonstandard book types enable ubiquitous reading of the disc 7 in substantially any DVD drive for the same beneficial results described above relative to creating nonstandard book types.

FIG. 2D shows a table 45 of book types in which the version numbers 48 have nonstandard binary values like the version numbers in FIG. 2C and the disc values 51 have nonstandard binary values like the disc values 33 in FIG. 2B. As may be appreciated, any combination of a version number 48 and a disc category 51 from the table 45 of FIG. 2D may be prerecorded to byte “0” to create a nonstandard book type. A nonstandard book type thus created allows ubiquitous reading of disc 7 in substantially any DVD drive for the same reasons described above relative to creating nonstandard book types.

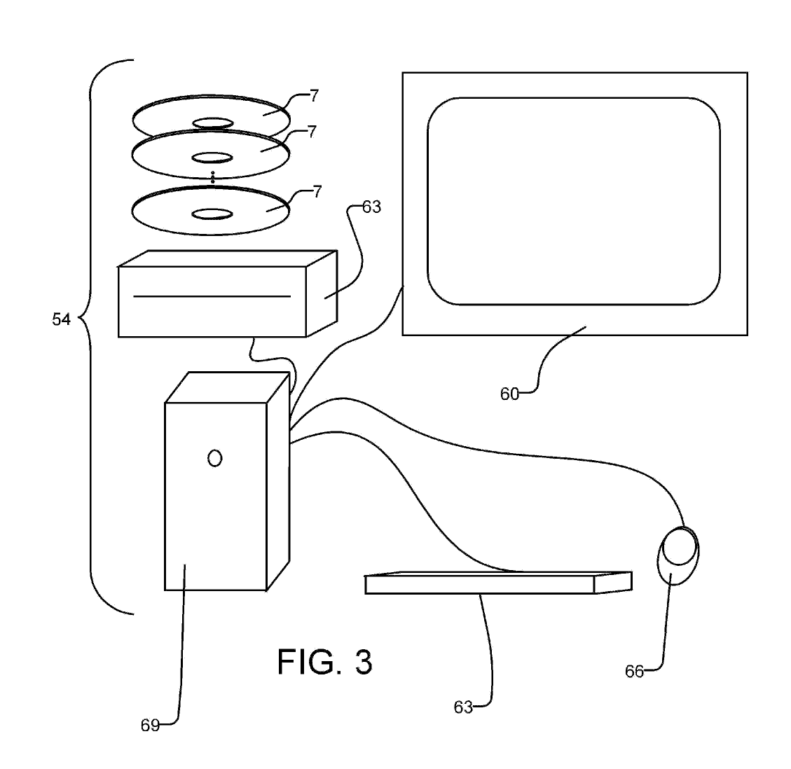

FIG. 3 shows a system 54 that may include one or more of a media drive 57, one or more user interfaces 60, 63, 66, a computer 69 for processing the data, and media discs 7. The user interfaces may include, but are not limited to, a visual display 60, a keyboard 63, and a mouse 66. It is to be understood that the drive 57 may include firmware that interfaces with the control data that is prerecorded on the media 7. The control data zone 15 of each disc 7 (see FIG. 1) includes a version code in byte “30” that calls for at least one strategy in the firmware of the drive 57. The version code is an identifier similar to the version numbers illustrated in FIGS. 2A-2D. In this case, the drive 57 is a writing device that is configured to create permanent marks in the recording area 10 of a media disc. (See FIGS. 1 and 3.) The version code is one of a variety of version codes recognized by the firmware and associated with a respective variety of strategies in the firmware.

Because one or both of the version number 21, 30, 39, 48 and the disc category 24, 33, 42, 51 that are prerecorded in byte “0” in the control data zone 15 may be nonstandard, it may be useful to have a separate identifier code on the media. The version code may be prerecorded to byte “30” at least in part for this purpose. It is to be understood that the version code of byte “30” may not be the same or may not even correlate to the version number or disc category of byte “0”. In fact, in one embodiment, the disc category may be a value corresponding to +R, and the version code in byte “30” may have a value that corresponds to −R. The version code also calls for at least one −R strategy in the firmware of the writing device 57. In another embodiment, the disc category that is prerecorded in byte “0” is +RW and the version code in byte “30” has a value corresponding to −RW and calls for at least one −RW strategy in the firmware of the writing device 57. In still another embodiment, the drive 57 is configured to operate in a +R mode on media that is set to a +RW disc category. By prerecording a nonstandard book type in byte “0”, identifying the disc version, and calling for a specific strategy in byte “30”, greater ubiquity in reading is achieved while enabling specific or isolated functionality in writing with the drive 57.

The system 54 enables hybridizing the reading and writing capabilities in the system 54 to gain the best functionality from a variety of media formats and systems. For example, the information media 7 may have an address data in pregroove (ADIP) system of tracking and speed control, which corresponds generally to “+” formats. Booting and reading the media 7 having the ADIP system in the control data zone may be enabled by the book type prerecorded in byte “0”. On the other hand, the version code of byte “30” may specify a −R write strategy, which generally corresponds to a land prepit (LPP) write strategy. The result is media 7 that provides the LPP strategy in the ADIP system. This has the advantage of superior tracking provided by the ADIP system and superior writing of a written portion 72 (shown in FIG. 1) provided by the LPP write strategy.

A digital information media writing device 57 may have firmware that includes at least one write strategy. The firmware may be configured to receive a request for use of one or more write strategies from a digital information media 7. The firmware may include multiple write strategies such as two, three, four, five, or more write strategies. These strategies may include LPP and/or ADIP strategies. One or more of the strategies may be automatically selected based on the information media 7 to which data is to be written. Version code(s) can specify the write strategy or strategies to be used for a particular media 7. It is to be understood that the version code(s) can be prerecorded to any byte inside or outside the control data zone. Also, it is to be understood that the firmware may provide a clock increment of one or more of ⅛, 1/16, 1/32, 1/64, and 1/128 of a clock cycle.

Methods of Preparation

Additional embodiments are directed towards methods of preparing digital information media. The methods include providing control data to a control data zone of the digital information media, in which the control data includes a book type having a nonstandard combination of a version number and a disc category. Placing the nonstandard book type in the control data zone may include stamping a data structure representing the version number and the disc category into a track at a position corresponding to the book type by a preformed stamper during manufacture of the media. Alternatively, placing the nonstandard book type in the track may include writing with a laser, etching, or by some other method.

The method of preparation may include placing data structure at various locations in the control data zone. For example, an identifier code such as a version code in the form of data structures may be placed in byte “30”. This identifier code and associated data may be configured to call for one or more write strategies, which may be placed as data structure in one or more extended information blocks in bytes 64 to 255 of the control data zone, for example. The control data zone on the media includes six extended information blocks. One or more write strategies may be placed in respective extended information blocks by placing the data structures representing the strategies at the appropriate positions of the tracks. Additionally, data structure further identifying the media by a manufacturer identification (MID) may be placed in bytes “26” to “29”. These various data structures may be placed by a stamper that has been preformed to stamp the data structure at the correct positions in the tracks during manufacture of the media. Alternatively, the data structures may be placed, (all or in part), by writing to the media with a laser, by etching, or in some other way. One or more of these identifying codes may be used to identify the permanent data storage optical information media and may form a basis for rejecting any request for writing to the media in a conventional drive. That is, the conventional drives will identify the media as nonstandard by one or more identifying codes and will not write to the media. In this way, the media is prepared in a manner that functionally isolates the media with respect to writing.

In one embodiment, the method includes providing an address data in pregroove (ADIP) system of tracking and controlling speed, and placing land prepit (LPP) strategy in the ADIP system. Thus, the method of preparation may include placing the data structure having LPP strategy or strategies in the appropriate locations on the track, such as in the area corresponding to the extended information blocks, for example. These blocks that receive the strategies may be ADIP blocks and may have an LPP strategy or strategies placed therein. The ADIP system corresponds generally to the +R formats, and the LPP formats correspond generally to the −R formats. Thus, in one embodiment, the method includes preparing a +R media having at least one −R write strategy. In fact, the write strategy may be a hybrid write strategy including features from both +R and −R formats. This is advantageous because the +R format enables superior control in creating 3T marks. The −R format enables relatively good control in creating 3T and 4T marks and enable control of other parameters that are important in write strategies. For example, the −R format enables superior control over power, delays, and pulse widths. Independent control over these parameters enables improved control over mark-to-mark interaction. Alternatively or additionally, the method of preparation may include placing data structure representing ROM in both ADIP and LPP portions of the data structure. Thus, the reading device will identify the media as a ROM type media.

The drives to be used for writing are also prepared for selectively writing to the permanent optical information storage media by providing the appropriate firmware. For example, the firmware may be configured to write at a rate of 1/16 (5×) for standard information blocks, and to write at speeds of 1/32 (6×), 1/64 (7×), and/or 1/128 (8×) to extended blocks. The higher speeds enable a higher resolution in pulses for greater precision in forming data marks. The drives are also configured with higher write powers than conventional drives that do not permanently record data. For example, a drive in accordance with one embodiment has a writing energy at the media of approximately sixty milliWatts (mW) when writing at a speed of 4×. Even higher write power is required for writing at higher speeds.

By placing the data structures discussed above in the media, a media of one type is prepared to include a write strategy of another type. For example, in one embodiment, the method includes preparing a +R media that includes a −R write strategy, which can be defined as a new format designated here as +M. This new format may include other features described herein without limitation. For example, the media having the new +M format may include data structures configured for permanently or non-permanently recording data at different speeds at different locations on the media.

Methods of Use

Additional embodiments are directed towards methods of using an optical information media and system for a generally ubiquitous read and a selective write.

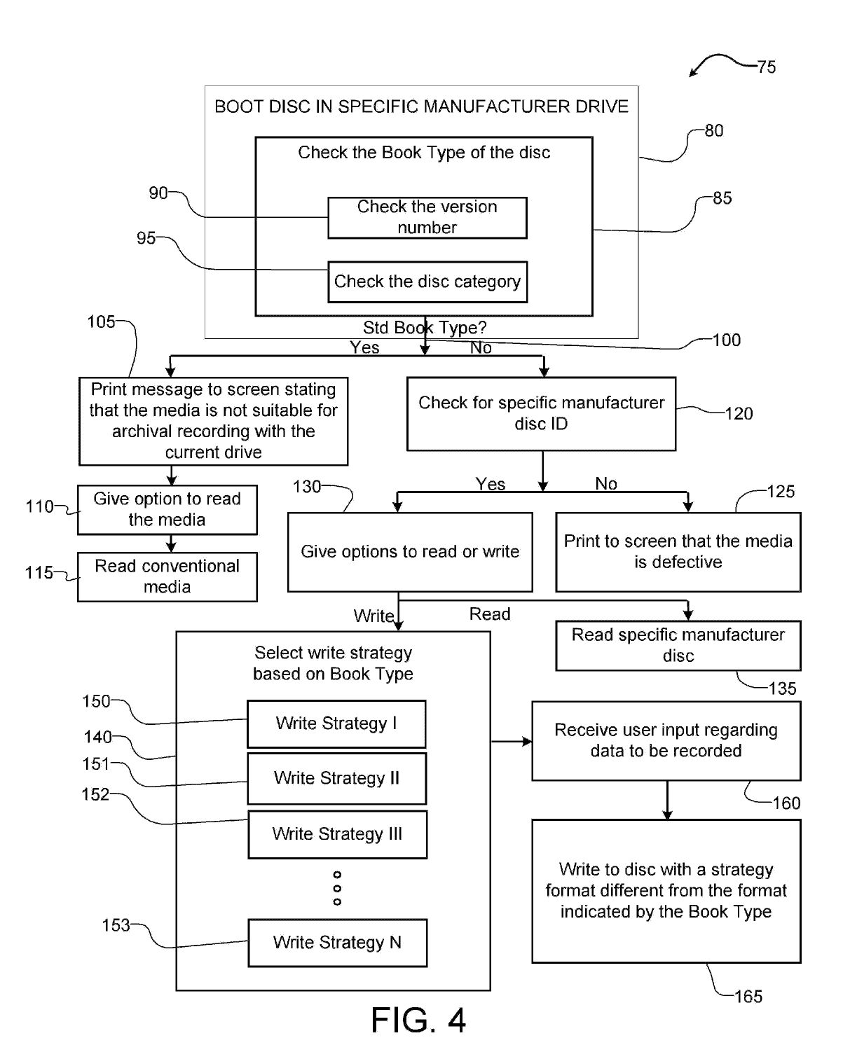

FIG. 4 shows a block diagram 75 illustrating a method of using a driver that is configured to permanently record data to an optical information media. The method provides selective writing. Booting the disc 80 includes checking the book type 85 of the disc by checking the version number 90 and the disc category 95. The method includes determining whether the book type is a standard book type or not, as indicated at 100. If the book type is standard, then the media is a conventional disc and the method prints a message to a screen or otherwise indicates that the media is not suitable for archival recording to the media with this particular drive, as indicated at 105. Then the method gives the user the option of reading the conventional media 110 and proceeds to read the media 115 if the user so chooses.

FIG. 4 also shows steps in the method when it is determined that the media has a nonstandard book type. In this case, the method checks the identifying codes on the media to confirm that the media is a disc made by a specific manufacturer, make and/or model, as indicated at 120. If the media lacks the proper ID for the specific manufacturer disc, then the method includes printing to a screen or some other indication that the media is defective, as indicated at 125. On the other hand, if codes on the media confirm that the disc is from the specific manufacturer, make, and/or model, then the method gives the user options of reading or writing, as indicated at 130. If the user selects reading the media, the method proceeds in reading the specific manufacturer disc 135. When the user chooses to write to the media, the method includes selecting a write strategy 140 for the specific disc.

In one embodiment, the method includes writing to the media in a specific DVD writer that has firmware keyed to the media. In this case, the firmware recognizes a disc category code and a version number that are prerecorded at byte “0” of a control data zone on the disc. Then the media calls for one or more write strategies 150, 151, 152, 153 in the firmware from another byte in the control data zone. The method then includes receiving the user's input regarding data to be recorded 160 and writing to the disc 165. It is to be understood that the method of using the optical information media and system may include writing to the media with a strategy that is for a format that is different from the format indicated by the book type of the media.

The method of using the driver that is configured to permanently record data to an optical information media includes using optical information media. In one embodiment, this aspect of the method includes providing the media with a +RW disc category in the control data zone and operating the DVD writer in a +R mode. In another embodiment, the method includes providing the media with a +RW disc category in the control data zone, and operating the DVD writer in a +R mode at least in part in accordance with a −R strategy.

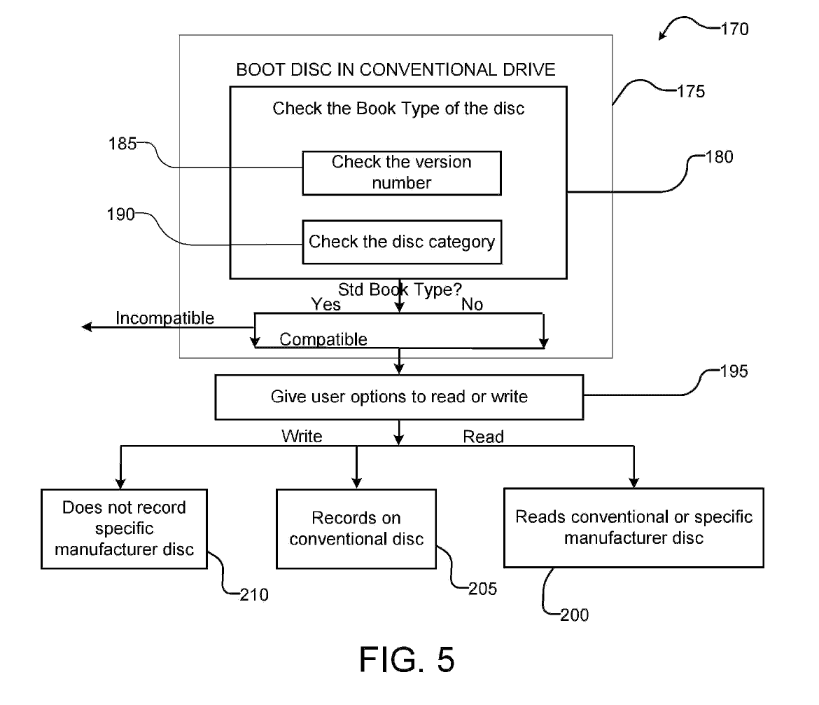

FIG. 5 shows a block diagram 170 illustrating a method of using a conventional drive for universally booting and/or reading an optical information media. The method facilitates ubiquitous reading and selective writing. As with the method of using illustrated in FIG. 4, the method of using the conventional drive includes booting the media in the conventional drive 175, checking the book type 180 by checking the version number 185 and the disc category 190. If the book type is standard then the conventional drive will either find the media compatible or incompatible. If the media is incompatible, then the media will not boot. If the book type is determined to be nonstandard then any conventional DVD drive will boot the media. A disc made by a specific manufacturer, having a specific make, and/or having a specific model, and having a nonstandard book type will universally boot in substantially all conventional drives. Such as disc, for example, may be a permanent data storage media by a specific manufacturer. The method includes giving the user the option of reading or writing 195. When the media is a conventional disc that is compatible with the conventional drive, then the user can successfully elect to read or write the disc, as indicated at 200, 205. If the media is a specific manufacturer disc having a nonstandard book type and the user attempts to write the disc, the drive will not be able to properly record data in the media and does not write to the media 210. The specific manufacturer disc will include instructions that will be conveyed to the user that the disc is not write compatible with the conventional drive. These instructions may include audio, video, and/or text that are automatically presented on a user's screen. The instructions may also inform the user that reading the disc is an available option in the conventional drive. The method includes reading the disc when the user elects to read the specific manufacturer disc. In one embodiment, the method includes operating a conventional DVD reader/writer in a +R mode, and reading the media in the conventional DVD reader/writer substantially independent of a model, make, and vintage of the DVD reader/writer.

### EXAMPLES

### Example 1

### Optical Information Media Providing Ubiquitous Read

A permanent data storage disc manufactured by Millenniata, Inc., Springville, Utah, 84663 was provided in accordance with specific architecture configured to enable permanent storage of the data to be written or copied thereto. The disc was also prerecorded by placing data structures in the control data zone. The data structures included a book type with a version number having a binary value of 0010₂ (ECMA-337) and a disc category having a binary value of 1010₂ (+R), which were placed in byte “0” of the control data zone. It is noted that this combination of version number and disc category constitutes a nonstandard book type. Data was written to the data recording area of the disc. Then the disc was booted in a large variety of conventional disc drives to determine whether the disc would boot and/or read in the drives. The disc was successfully booted and read in various drives in which it was tested.

It is to be understood that the various embodiments and features may be combined in any manner. Some terms are used interchangeably throughout this disclosure. For example, the term “media” and the term “disc” are interchangeable. Although the term “media” is considered to be broader than the term “disc”. The term “drive” is used to generally refer to a media reader, media writer, or both, without limitation.

All of the compositions and/or methods and/or processes and/or apparatus disclosed and claimed herein can be made and executed without undue experimentation in light of the present disclosure. While the compositions and methods have been described, it will be apparent to those of skill in the art that variations may be applied to the compositions and/or methods and/or apparatus and/or processes and in the steps or in the sequence of steps of the methods described herein. More specifically, it will be apparent that certain agents which are both chemically and physically related may be substituted for the agents described herein while the same or similar results would be achieved. All such similar substitutes and modifications apparent to those skilled in the art are deemed to be contemplated.

What is claimed is:

1. A digital information media, comprising:
a control data zone including a book type having a binary value that indicates a nonstandard version number or a nonstandard disc category;
the book type being not from the list of book types in big endian format consisting of 0000₂ 0001₂, 0001₂ 0001₂, 0001₂ 0110₂, 0010₂ 0001₂, 0010₂ 0101₂, 0011₂ 0010₂, 1001₂ 0001₂, 1001₂ 0010₂, 1001₂ 0011₂, 1010₂ 0001₂, 1101₂ 0001₂, and 1110₂ 0001₂.

2. The digital information media of claim 1, wherein the nonstandard version number is 0010₂ and the nonstandard disc category is 1010₂.

3. The digital information media of claim 1, wherein the nonstandard version number is 0010₂ and the nonstandard disc category is 0000₂ (ROM).

4. The digital information media of claim 1, wherein the nonstandard disc category is selected from among 0100₂, 0101₂, 0110₂, 0111₂, 1000₂, 1011₂, 1100₂, and 1111₂.

5. The digital information media of claim 1, wherein the nonstandard version number is selected from among 0000₂, 0100₂, 0111₂, 1000₂, 1001₂, 1010₂, 1011₂, 1100₂, 1101₂, 1110₂, and 1111₂.

6. The digital information media of claim 1, wherein the control data zone comprises a version code in byte 30 that calls for at least one strategy in a firmware of a writing device.

7. The digital information media of claim 1, wherein
a disc category is +R; and
the control data zone comprises a version code in byte “30” that calls for at least one −R strategy in a firmware of a writing device.

8. The digital information media of claim 1, wherein
a disc category is +RW; and
the control data zone comprises a version code in byte 30 that calls for at least one −RW strategy in a firmware of a writing device.

9. The digital information media of claim 1, further comprising:
an address data in pregroove (ADIP) system of tracking and speed control; and
a land prepit (LPP) strategy in the ADIP system.

10. A digital information media writing device, comprising:
firmware configured to include at least one write strategy;
the firmware configured to receive a request for use of the write strategy from a digital information media;
wherein the firmware provides a clock increment of at least one of ⅛, 1/16, 1/32, 1/64, and 1/128 of a clock cycle.

11. The digital information media of claim 11, wherein the firmware is configured to include at least five write strategies, in which one of the strategies is automatically selected based on an information media to which data is to be written.

12. The digital information media of claim 11, wherein the drive is configured to operate in a +R mode on media set to a +RW disc category.

13. A method for preparing digital information media, the method comprising providing control data to a control data zone of the digital information media that includes a book type having a nonstandard combination of a version number and a disc category.

14. The method of claim 13, further comprising:
providing an address data in pregroove (ADIP) system of tracking and controlling speed; and
placing land prepit (LPP) strategy in the ADIP system.

15. A method for using digital information media, the method comprising:
writing to the media in a DVD writer having firmware keyed to the media where the firmware recognizes a disc category code and a version number prerecorded in byte “0” of a control data zone; and
the media calls for at least one write strategy in the firmware from another byte in the control data zone.

16. The method of claim 15, further comprising:
operating the DVD writer in a +R mode; and
reading the media in a conventional DVD reader substantially independent of a model, make, or vintage of the DVD reader.

17. The method of claim 15, further comprising:
providing the media with a +RW disc category in the control data zone; and
operating the DVD writer in a +R mode.

18. The method of claim 15, further comprising:
providing the media with a +RW disc category in the control data zone; and
operating the DVD writer in a +R mode at least in part in accordance with a −R strategy.
